(19) United States
(12) Patent Application Publication
(10) Pub. No.: US 2026/0015205 A1
(43) Pub. Date: Jan. 15, 2026

(54) ELEVATOR SAFETY CONTROL DEVICE, METHOD FOR ELEVATOR SAFETY CONTROL AND ELEVATOR SYSTEM

(71) Applicant: Otis Elevator Company, Farmington, CT (US)

(72) Inventor: Longwen Wang, Shanghai (CN)

(21) Appl. No.: 19/257,658

(22) Filed: Jul. 2, 2025

(30) Foreign Application Priority Data
Jul. 11, 2024 (CN) 202410928771.0

(51) Int. Cl. B66B 5/16; B66B 5/06; B66B 5/12

(52) U.S. Cl. CPC B66B 5/16; B66B 5/06; B66B 5/125; B66B 2201/46

(57) ABSTRACT

An elevator safety control device includes an interface unit that receives a first status signal of a first safety switch, a second status signal of a second safety switch, and a third status signal of a non-safety function unit of an elevator, the second safety switch including a plurality of landing door switches whose status can be determined individually; a safety controller that performs: determining an occurrence of an abnormal event based on the first status signal, the second status signal and the third status signal; determining, after determining the occurrence of the abnormal event, a possibility of a target landing door based on the second status signal; and executing a rescue mode after determining an existence of the possibility, wherein in the rescue mode, the car is caused to travel by gravity and stop at the target landing door by controlling a state of a holding brake device.

### FOREIGN PRIORITY

This application claims priority to Chinese Patent Application No. 202410928771.0, filed Jul. 11, 2024, and all the benefits accruing therefrom under 35 U.S.C. § 119, the contents of which in its entirety are herein incorporated by reference.

### TECHNICAL FIELD

The present disclosure relates to elevator technology and, in particular, to an elevator safety control device, a method for elevator safety control, an elevator system comprising the device, a non-transitory computer-readable storage medium for implementing the method, and a computer program product.

### BACKGROUND

When safety switches (e.g. landing door switches) are triggered or non-safety function units of an elevator, such as controllers and drivers, fail, a car will stop moving and a door will be prevented from opening, leaving passengers trapped and waiting for rescue. Even if safety performance of an elevator system is improved to a high level, it is still not possible to completely prevent passengers from being trapped in the elevator. Therefore, there is an urgent need to provide ability to timely deal with trapped situations.

### SUMMARY

In accordance with an aspect of the present disclosure, an elevator safety control device, a method for elevator safety control, an elevator system comprising the device, a non-transitory computer-readable storage medium for implementing the method, and a computer program product are provided.

In accordance with an aspect of the present disclosure, an elevator safety control device comprises an interface unit and a safety controller. The interface unit is configured to receive a first status signal of a first safety switch, a second status signal of a second safety switch, and a third status signal of a non-safety function unit of an elevator, wherein the second safety switch comprises a plurality of landing door switches whose status can be determined individually. The safety controller is configured to determine an occurrence of an abnormal event based on the first status signal, the second status signal and the third status signal, to determine, after determining the occurrence of the abnormal event, a possibility of a car stopping at a landing door of the nearest floor based on the second status signal, and to execute a rescue mode after determining an existence of the possibility, wherein in the rescue mode, the car is caused to travel by gravity and stop at the landing door of the nearest floor by controlling a state of a holding brake device.

In accordance with another aspect of the present disclosure, an elevator system comprises a car, a non-safety function unit of an elevator, a first safety switch, a second safety switch, a holding brake device and an elevator safety control device. The second safety switch comprises a plurality of landing door switches whose status can be determined individually. The elevator safety control device comprises an interface unit and a safety controller. The safety controller is configured to determine an occurrence of an abnormal event based on the first status signal, the second status signal and the third status signal, to determine, after determining the occurrence of the abnormal event, a possibility of a car stopping at a landing door of the nearest floor based on the second status signal, and to execute a rescue mode after determining an existence of the possibility, wherein in the rescue mode, the car is caused to travel by gravity and stop at the landing door of the nearest floor by controlling a state of the holding brake device.

In accordance with still another aspect of the present disclosure, in a method for elevator safety control, a first status signal of a first safety switch, a second status signal of a second safety switch, and a third status signal of a non-safety function unit of an elevator are received, an occurrence of an abnormal event is determined based on the first status signal, the second status signal and the third status signal, after determining the occurrence of the abnormal event, a possibility of a car stopping at a landing door of the nearest floor is determined based on the second status signal, and a rescue mode is executed after determining an existence of the possibility.

In accordance with still another aspect of the present disclosure, there is provided a non-transitory computer-readable storage medium having stored thereon a computer program/instruction that implements the steps of the method as described above when the computer program/instruction is executed by a processor.

In accordance with a still further aspect of the present disclosure, there is provided a computer program product comprising a computer program/instruction that implements the steps of the method as described above when the computer program/instruction is executed by a processor.

### DESCRIPTION OF THE DRAWINGS

The above and/or other aspects and advantages of the present disclosure will be clearer and more easily understood from the following description of various aspects in conjunction with the accompanying drawings, in which the same or similar units are denoted by the same reference numerals. The accompanying drawings include:

FIG. 1 is a view of an exemplary elevator system.

FIG. 2 is a schematic block diagram of an elevator system in accordance with an embodiment of the present disclosure.

FIG. 3 is a schematic block diagram of an elevator safety control device in accordance with another embodiment of the present disclosure.

FIG. 4 is a schematic diagram of a landing door switch array in accordance with another embodiment of the present disclosure.

FIG. 5 is a schematic diagram of a landing door switch array in accordance with further embodiment of the present disclosure.

FIG. 6 is a flowchart of a method for determining a state of a landing door switch in accordance with another embodiment of the present disclosure.

FIG. 7 is a flowchart of a method for elevator safety control in accordance with another embodiment of the present disclosure.

FIG. 8 is a schematic block diagram of a safety controller in FIG. 3.

### DETAILED DESCRIPTION

The present disclosure is described more fully below with reference to the accompanying drawings, in which illustrative embodiments of the present disclosure are illustrated. However, the present disclosure may be implemented in different forms and should not be construed as limited to the embodiments presented herein. The presented embodiments are intended to make the disclosure herein comprehensive and complete, so as to more comprehensively convey the protection scope of the present disclosure to those skilled in the art.

In this specification, terms such as “comprising” and “including” mean that in addition to units and steps that are directly and clearly stated in the specification and claims, the technical solution of the present disclosure does not exclude the presence of other units and steps that are not directly or clearly stated in the specification and claims.

In this specification, a landing station usually refers to a location on each floor that are used for the entry and exit of passenger objects (e.g., passengers, machinery and equipment, etc.) to and from the car.

In this specification, elevator safety functions refer to a variety of elevator safety-related functions, which include, for example, but are not limited to: emergency brake function (automatically activating an emergency brake system to stop the car in an emergency), door safety function (for ensuring that an elevator door remains closed during operation), overspeed protection function (for preventing the car from moving faster than a safety speed), overload protection (for preventing the car from overload operation), emergency alarm and communication function, safety link monitoring function (for monitoring status of multiple safety switches to ensure that all safety-related components are operating properly), holding brake status monitoring function (for monitoring whether the holding brake device is in a normal operating condition), leveling control function (for ensuring that the elevator stops accurately when it reaches a designated floor) and anti-pinch function (for detecting the appearance of obstacles when the elevator door is closing), etc. (for detecting obstacles that appear when the elevator door is closed), etc.

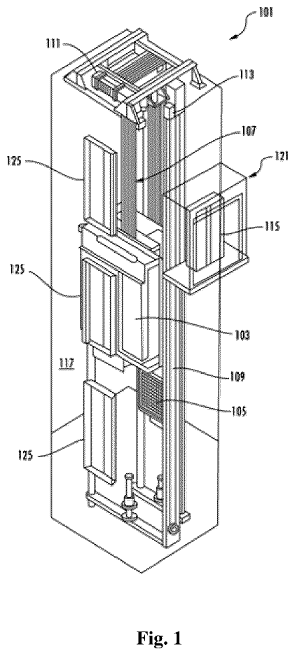

FIG. 1 is a view of an exemplary elevator system. An elevator system 101 shown in FIG. 1 includes an elevator car 103, a counterweight 105, a tensioning component 107, a guide rail (or rail system) 109, a unit (or unit system) 111, a position reference system 113, and an electronic elevator controller (controller) 115. The elevator car 103 and the counterweight 105 may be connected to each other via the tensioning component 107. The tensioning component 107 may include or be configured as, for example, a rope, a steel cable, and/or a coated steel strip. The counterweight 105 is configured to balance a load of the elevator car 103 and is configured to assist in moving the elevator car 103 within an elevator shaft (or shaft) 117 and along the guide rail 109 in opposite directions relative to the counterweight 105 simultaneously.

The tensioning component 107 may engage the unit 111, the unit 111 may be part of a header structure of the elevator system 101. The unit 111 is configured to control movement between the elevator car 103 and the counterweight 105. The position reference system 113 may be mounted on a fixed portion at the top of the elevator shaft 117, such as on a support member or guide rail, and may be configured to provide a position signal related to the position of the elevator car 103 within the elevator shaft 117. In other embodiments, the position reference system 113 may be mounted directly to a moving assembly of the unit 111, or may be located in other locations and/or configurations as known in the art. The position reference system 113 may be any device or mechanism for monitoring the position of the elevator car and/or the counterweight as is known in the art. As may be appreciated by those skilled in the art, the position reference system 113 includes, for example, but is not limited to, an encoder, a sensor, or other systems, and may implement various sensing such as velocity sensing, absolute position sensing, and the like.

As shown, the controller 115 is located in a controller compartment 121 of the elevator shaft 117 and is configured to control operation of the elevator system 101 (and in particular, the elevator car 103). For example, the controller 115 may provide a drive signal to the unit 111 to control acceleration, deceleration, leveling, stopping, and the like of the elevator car 103. The controller 115 may also be configured to receive the position signal from the position reference system 113 or any other desired position reference device. While moving up or down along the guide rail 109 within the elevator shaft 117, the elevator car 103 may stop at one or more landing stations 125 as controlled by the controller 115. Although shown in the controller compartment 121, those skilled in the art will appreciate that the controller 115 may be located and/or configured at other places or locations within the elevator system 101. In an embodiment, the controller may be remotely located or located in a cloud.

The unit 111 may include a motor or similar drive mechanism. According to embodiments of the present disclosure, the unit 111 is configured to include an electrically driven motor. A power source for the motor may be any power source, including a power grid, the power source being supplied to the motor in combination with other components. The unit 111 may include a traction pulley, the traction pulley transmitting force to the tensioning component 107 to move the elevator car 103 within the elevator shaft 117.

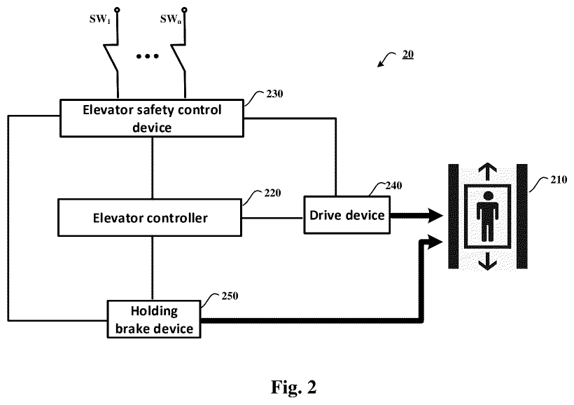

FIG. 2 is a schematic block diagram of an elevator system in accordance with an embodiment of the present disclosure. As shown in FIG. 2, an elevator system 20 includes a car 210, an elevator controller 220 (e.g., controller 115 in FIG. 1), an elevator safety control device 230, a drive device 240 (e.g., unit 111 in FIG. 1), a holding brake device 250, and a plurality of safety switches SW₁ to SWₙ.

Based on a control command from the elevator controller 220, the drive device 240 controls movement between the car 210 and the counterweight so that the car 210 can stop at a desired floor. In a normally operating elevator system, under the control of the elevator controller 220, the holding brake device 250 enters a holding state to keep the car 210 stationary at the current position when the car 210 stops at the landing door, and is in a loosening state during the movement of the car 210 towards the landing door.

In this embodiment, the elevator safety control device 230 is configured as a hardware unit that performs one or more of the above-described elevator safety-related functions (e.g., an emergency brake function, a door safety function, an overspeed protection function, a safety link monitoring function, and a holding brake status monitoring function, etc.). In addition, the elevator safety control device 230 is further configured to perform a rescue mode as will be detailed below.

In the elevator system shown in FIG. 2, the elevator safety control device 230 is connected with the safety switches SW₁ to SWₙ or with a device for detecting the state of the safety switches SW₁ to SWₙ (e.g., sensors for sensing the safety switch devices and the landing door switch array that will be described in detail below, etc.,). In the following description, the safety switches other than the landing door switches are collectively referred to as the first safety switch, and the landing door switches are also referred to as the second safety switch. Exemplarily, the first safety switches include, for example, but are not limited to, limit switches, overspeed switches, upward overspeed switches, pit climb switches, mechanical device non-operating position indicator switches, steel belt or wire rope slack trigger switches, speed limiter rope tension indicator switches, car door switches, pit stopping switches, safety window switches, car roof stopping devices, bumper switches, main engine stopping devices, and emergency stopping operation panel switches.

The elevator safety control device 230 may also communicate with the elevator controller 220 and the drive device 240. Further, in the rescue mode, the elevator safety control device 230 takes over the holding brake device 250 from the elevator controller 220 (e.g., by disconnecting the power supply of the elevator controller 220 and establishing a communication connection between the elevator safety control device 230 and the holding brake device 250, etc.).

In this embodiment, the elevator safety control device 230 determines whether an abnormal event has occurred based on the status signals about the safety switches SW₁ to SWₙ and the status signal about the non-safety function unit of the elevator (e.g., the elevator controller 220 and the drive device 240, etc.).

Further, after determining that the abnormal event has occurred, the elevator safety control device 230 determines whether or not there is a possibility of the car 210 stopping at a landing door of the nearest floor (hereinafter, the landing door of the nearest floor is also referred to as the target landing door) and executes the rescue mode after determining that there is the above possibility. The manner of determining the possibility of stopping at the landing door of the nearest floor will be described in detail below.

Normally, when an abnormality such as an abnormal disconnection of the landing door switch occurs, the holding brake device will be in a holding state under the control of the elevator controller to ensure that the car stops running. Unlike the above, in the rescue mode, the power supply to the non-safety function unit of the elevator is cut off, and the control of the holding brake device 250 is transferred to the elevator safety control device 230. At this time, the elevator safety control device 230 controls the state of the holding brake device 250 based on the speed of movement of the car 210 (e.g., if the speed of movement exceeds the safety speed, the holding brake device is put into the holding state to reduce the speed of movement, if the speed of movement does not exceed the safety speed, the holding brake device is kept in a loosened state), so that the car 210 travels by gravity to the landing door of the nearest floor, and a car controller is instructed to open the door of the car when the car 210 stops at the target landing door. Exemplarily, a rescue encoder or the position reference system 113 of FIG. 1 may be utilized to determine the speed of movement of the car.

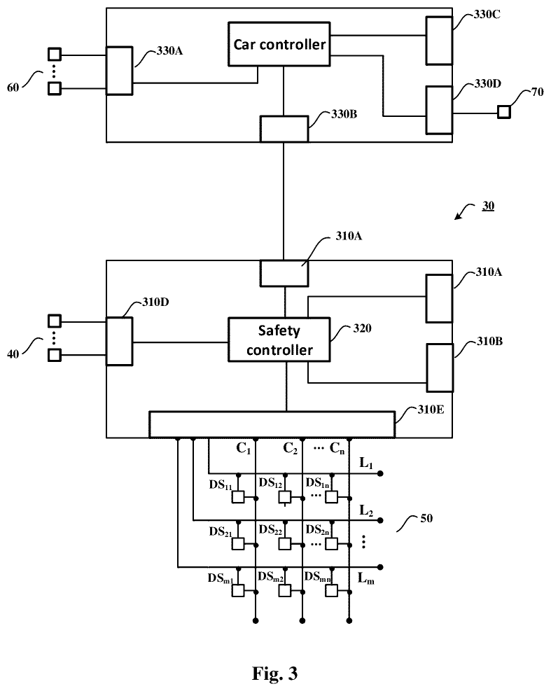

FIG. 3 is a schematic block diagram of an elevator safety control device in accordance with another embodiment of the present disclosure, which illustrates an exemplary implementation of the elevator safety control device 230 of FIG. 2.

An elevator safety control device 30 shown in FIG. 3 includes an interface unit 310 and a safety controller 320 that are typically provided on the side of an elevator control cabinet, which may be integrated, for example, on a printed circuit board. In addition, the elevator safety control device 30 may also include an interface unit and a car controller 340 located on the car side, which may for example also be integrated on a printed circuit board. The interface unit may include various interfaces, such as a CAN bus interface 310A for communicating with the elevator controller 220 and the drive device 240 of FIG. 2, a control port 310B for controlling the holding brake device 250, a safety CAN bus interface 310C for communicating with the car controller 340, an interface 310D for connecting with an encoder and a sensor 40 for sensing the state of the first safety switch for receiving the corresponding status signal, and an interface 310E for connecting with a landing door switch array 50, which will be described in more detail below.

The sensor 40 may comprise a plurality of sensor units for sensing the state of limit switches, overspeed switches, upward overspeed switches, pit climb switches, mechanical device non-operating position indicator switches, steel belt or wire rope slack trigger switches, and speed limiter rope tension indicator switches, respectively. First safety switches such as car door switches, pit stopping switches, safety window switches, car roof stopping devices, bumper switches, main engine stopping devices, and emergency stopping operation panel switches are typically located on the car side. To this end, the interface unit may include an interface 330A connected with a sensor 60 that senses the state of these safety switches to receive corresponding status information. In addition, the interface unit 330 may also include a safety CAN bus interface 330B for communicating with the safety controller 320, a CAN bus interface 330C for communicating with the elevator controller 220 and the drive device 240, and a sensing signal interface 330D for connecting with a trapped sensor 70 for sensing the trapped state of the passengers.

In this embodiment, the safety controller 320 may determine whether an abnormal event has occurred based on the status signals of the safety switches and the non-safety function unit of the elevator, and after determining that the abnormal event has occurred, determine whether or not there is a possibility of the car stopping at a landing door of the nearest floor based on the status signals of the landing door switches provided by the landing door switch array 50, and after determining that there is such a possibility, execute a rescue mode to cause the car to travel to the target landing door and stop at the target landing door. In some examples, during execution of the rescue mode, the safety controller 320 will monitor the status signals of the landing door switches to determine whether the target landing door is still safe (e.g., whether the landing door switches of the target landing door are malfunctioning), and once it is determined that it is unavailable or unsafe, exit the rescue mode and keep the car stationary at the current position with the aid of the holding brake device.

The following describes the method for determining the abnormal event.

In some examples, the safety controller 320 determines that the abnormal event has occurred if status signals received from the sensors 40, 60 and the landing door switch array 50 indicate that at least one of the following safety switches is in an open state: a landing door switch, a limit switch, an overspeed switch, an upward overspeed switch, a pit climb switch, a mechanical device non-operating position indicator switch, a steel belt or wire rope slack trigger switch, and a speed limiter rope tension indicator switch.

In other examples, the safety controller 320 determines that the abnormal event has occurred if status signals received from the sensors 40, 60 indicate that at least one of the following safety switches is in an open state and signals indicative of a rescue request or indicative of a passenger being trapped are received from a device external to the elevator safety control device 230 (e.g., the elevator controller 220 and the trapped sensor 70, etc.): a car door switch, a pit stopping switch, a safety window switch, a car roof stopping device, a bumper switch, a main engine stopping device, and an emergency stopping operation panel switch.

In still other examples, the safety controller 320 determines that the abnormal event has occurred if the status signal of the non-safety function unit of the elevator indicates that it is malfunctioning (including an inability to establish a communication connection with the safety controller 320).

The following describes the structure and operating principle of the landing door switch array.

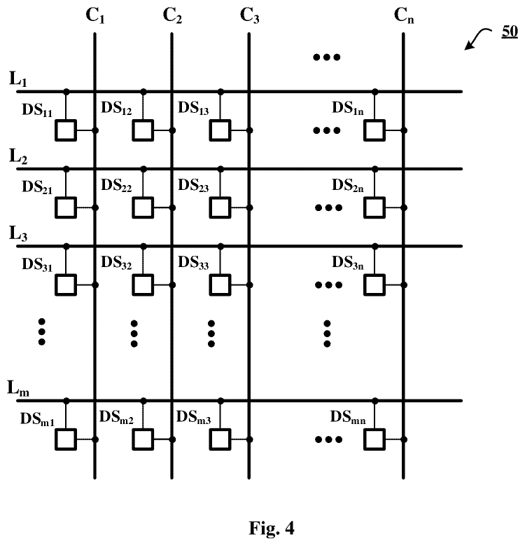

Unlike the manner in which all of the landing door switches are connected in series to form a safety link, in embodiments of the present disclosure, the landing door switches may be organized in the form of the landing door switch array, wherein each landing door switch corresponds to one of the nodes of the landing door switch array. In the following description, the terms “landing door switch” and “node” are used interchangeably unless otherwise specified. Taking the case in which the m×n landing door switches are equally divided into m switch groups as an example, FIG. 4 shows a schematic diagram of the landing door switch array corresponding to the case. Referring to FIG. 4, the landing door switch array 50 contains m signal input lines L₁ to Lₘ that are not connected to each other, n signal output lines C₁ to Cₙ, and a plurality of nodes located near intersections of the signal input lines and the signal output lines. Taking the jth landing door switch DSᵢⱼ within the i^{th} switch group as an example, it is located near the intersection of the i^{th} signal input line Lᵢ and the jth signal output line Cⱼ, and its input end and output end are connected with the i^{th} signal input line Lᵢ and the jth signal output line Cⱼ, respectively. As a result, each row of the landing door switch array corresponds to one of the switch groups, and each column of the landing door switch array corresponds to a column comprising the landing door switches having the same serial number j within each switch group. As a result, each landing door switch is connected between a corresponding signal input line and a signal output line in the form of the array shown in FIG. 4. By applying a detection signal onto only one of the plurality of signal input lines at a time and simultaneously detecting a response signal on each of the signal output lines, a state (e.g., a closed state and an open state) of each of the landing door switches within the switch group corresponding to the signal input line to which the detection signal is applied can be determined. Exemplarily, a signal level on the signal output line may characterize the response signal.

Taking the elevator system containing 9 landing door switches equally divided into three switch groups G₁ to G₃ as an example (m=3, n=3), the signal input lines L₁ to L₃ are connected with an input end of each landing door switch within one of the switch groups Gi to G₃ respectively, for example, the signal input line L₁ is connected with the input ends of the landing door switches DS₁₁ to DS₁₃ within the switch group G₁, the signal input line L₂ is connected with the input ends of the landing door switches DS₂₁ to DS₂₃ within the switch group G₂, and the signal input line L₃ is connected with the input ends of the landing door switches DS₃₁ to DS₃₃ within the switch group G₃; on the other hand, the signal output lines C₁ to C₃ are connected with an output end of one of the landing door switches within each of the switch groups G₁ to G₃, for example, the signal output line C₁ is connected with the output ends of the landing door switches DS₁₁, DS₂₁, and DS₃₁, the signal output line C₂ is connected with the output ends of the landing door switches DS₁₂, DS₂₂, and DS₃₂, and the signal output line C₃ is connected with the output ends of the landing door switches DS₁₃, DS₂₃, and DS₃₃.

It should be noted that the number of landing door switches does not ensure that they satisfy the condition of being equally divided into a plurality of switch groups, and thus the number of landing door switches within each switch group may or may not be consistent. Taking the elevator system containing 12 landing door switches as an example, these landing door switches may be divided into 4 groups, each containing 3 landing door switches. Taking the elevator system containing 19 landing door switches as an example, these landing door switches may be divided into 5 groups, with each of the first 4 groups containing 4 landing door switches, and the last group containing 3 landing door switches. In short, various divisions may be used to group the landing door switches.

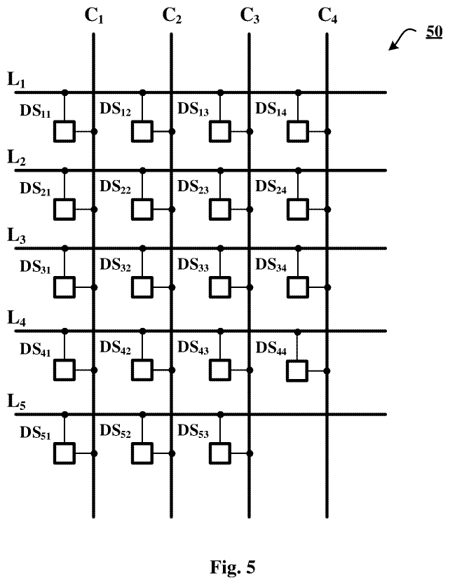

It should also be noted that in the case where the number of landing door switches within each switch group is not the same, it is also possible to connect the landing door switches with the signal input lines and the signal output lines in accordance with the form of the landing door switch array similar to that shown in FIG. 4, in order to realize an individual determination of the state of each landing door switch. Taking the elevator system containing 19 landing door switches as an example, these landing door switches may, for example, be connected with the signal input lines and the signal output lines in accordance with the form of the landing door switch array 50 shown in FIG. 5. As will be recognized upon reading the present disclosure, the inability of the landing door switches to be equally divided into switch groups does not pose an obstacle to the implementation of the function of detecting the state of the landing door switch described herein.

Continuing with FIG. 3, the interface 310E of the safety controller 320 comprises a group of I/O ports or I/O channels 311 connected with the signal input lines and the signal output lines. During the execution of the function of detecting, the safety controller 320 applies a detection signal S on one of the signal input lines via the corresponding I/O port and reads a response signal S′ on the signal output line via the corresponding I/O port. If the response signal S′ has similar characteristics to the detection signal S (e.g., including, but not limited to, one or more of the following: signal amplitude, signal waveform, spectral component, and half-peak width, etc.), then it is determined that the corresponding landing door switch is in a closed state, otherwise, it is determined that it is in an open state. For example, in order to determine the state of the landing door switch DS₂₃ in FIG. 4, the safety controller 320 may apply a detection signal S on the signal input line L₂ and read a response signal S′ on the signal output line C₃. In some examples, the safety controller 320 may determine the state of each of the landing door switches by applying the detection signal S sequentially onto the signal input lines L₁ to Lₘ and reading the response signals of the signal output lines C₁ to Cₙ.

Various signals may be used as the detection signals, such as including, but not limited to, pulse signals, constant level signals, and pulse width modulated signals. The use of pulse signals as the detection signals helps to accurately detect the response signals in a strong noise environment, avoiding the use of cable wires with strong electromagnetic shielding capabilities as the signal input lines and signal output lines.

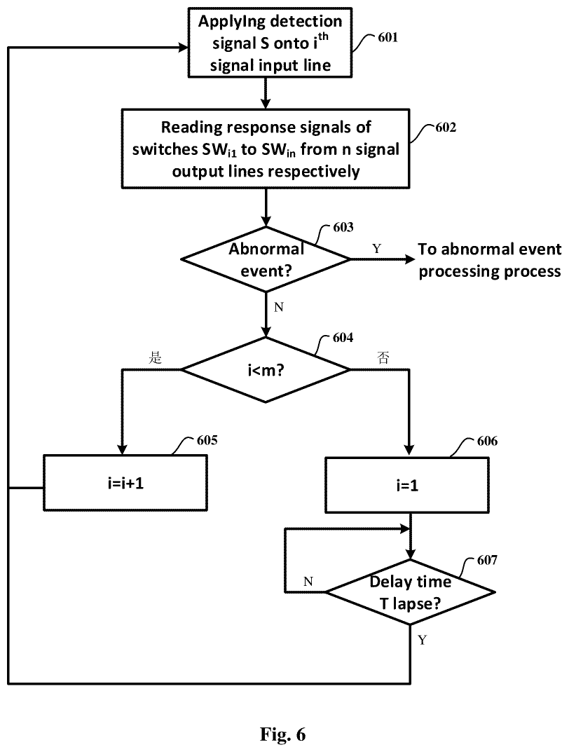

FIG. 6 is a flowchart of a method for determining a state of a landing door switch in accordance with another embodiment of the present disclosure.

The method shown in FIG. 6 begins at step 601. Taking the landing door switch array shown in FIG. 4 as an example, in step 601, the safety controller 320 applies a detection signal S (e.g., a pulse signal, a constant level signal, or a pulse width modulated signal, etc.) onto the i^{th} signal input line. In the operation cycle comprising steps 601 to 605, i takes the value of 1 when step 601 is first performed.

Subsequently, proceeding to step 602, the safety controller 320 reads the response signals S′ᵢ₁ to S′ᵢₙ of the landing door switches DSᵢ₁ to DSᵢₙ from n signal output lines respectively to determine the state of these landing door switches.

Next, in step 603, the safety controller 320 determines whether an abnormal event has occurred based on the state of the landing door switches DSᵢ₁ to DSᵢₙ. If the abnormal event has occurred, it proceeds to an abnormal event processing process, otherwise, it proceeds to step 604.

In the case of normal operation of the elevator system, after the car stops at the target landing door, a door interlocking device of the landing door will change from a locked state to an unlocked state, at which time the landing door will be opened and the corresponding landing door switch will enter an open state. On the other hand, a malfunction of the elevator system may also cause the door interlocking device to enter the unlocked state (at which time the landing door is in the open state), and accordingly, the landing door switch is in the open state. Such unlocking without active control puts the passengers at great risk, especially if the car is in motion or if the car is in a non-stop position. In some examples, the open of the landing door switch caused by the door interlocking device entering the unlocked state without active control is considered an abnormal event. In the abnormal event processing process, the safety controller 320 will determine, in response to the occurrence of the abnormal event, whether there is a possibility of the car stopping at the landing door of the nearest floor. If such a possibility exists, the safety controller 320 performs a rescue mode to cause the car to travel to and stop at the target landing door.

In step 604, the safety controller 320 will determine whether the application of the detection signal S has traversed the m signal input lines or whether the m signal input lines have been sequentially applied with the detection signal S. If the condition is satisfied, it proceeds to step 605, otherwise, it proceeds to step 606. In some examples, a counter may be set to count the number of times i that the detection signal has been applied, whereby determination may be made based on a comparison result of the current count value and the m. For example, if the current count value i<m, it is determined that all signal input lines have not been traversed.

In step 605, the safety controller 320 will increment the serial number of the signal input line to which the detection signal S is to be applied next or the count value of the counter, i.e., i=i+1.

After step 605, the flow shown in FIG. 6 returns to step 601. In this step, the safety controller 320 continues to apply the detection signal S onto the remaining signal input lines in sequence.

In another branch step 606 of step 604, the safety controller 320 will reset the serial number of the signal input line to which the detection signal S is to be applied next or the count value of the counter to one.

Subsequently, proceeding to step 607, the safety controller 320 determines whether or not a set delay time T is experienced, and if the determination result is true, returns to step 601 to restart a new operation cycle comprising steps 601 to 605, otherwise, continues to wait. By setting this delay time T, the execution cycle of the state detection operation of the plurality of landing door switches can be adjusted.

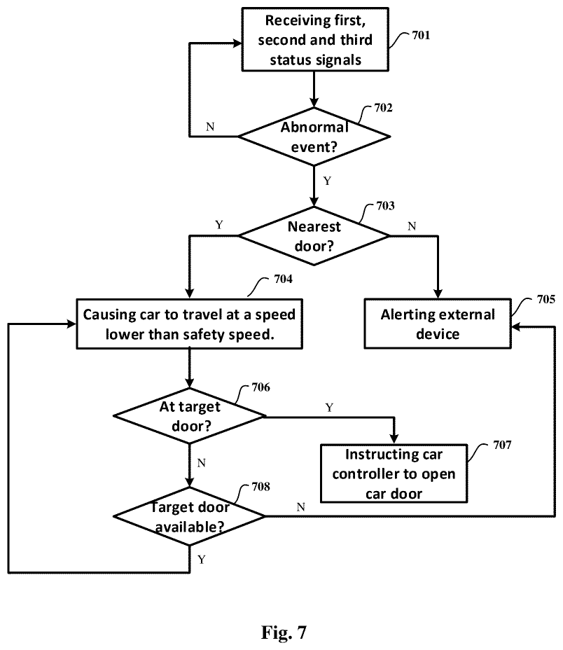

FIG. 7 is a flowchart of a method for elevator safety control in accordance with another embodiment of the present disclosure. The method described below may be implemented by various control devices, including, for example, but not limited to, the elevator safety control device 230 in FIG. 2 and the safety controller 320 in FIG. 3, and the like. In this embodiment, similar to the previous embodiments, the landing door switches are also organized as a plurality of switch groups and form a landing door switch array in accordance with a manner similar to that shown in FIG. 4 or 5.

The method shown in FIG. 7 begins at step 701. In this step, the control device receives a first status signal about the first safety switch from the sensors 40 and 60, a second status signal from the landing door switch array 50 (e.g., a response signal on the output line in FIG. 4), and a third status signal from the non-safety function unit of the elevator (e.g., a CAN bus signal received via the signal interface 310, etc.).

Subsequently, proceeding to step 702, the control device determines whether an abnormal event has occurred based on the first status signal, the second status signal, and the third status signal. If the abnormal event has occurred, it proceeds to step 703, otherwise it returns to step 701. The method of determining the abnormal event has been described above, and will not be repeated herein.

In step 703, the control device determines, based on the second status signal of the landing door switch array 50, whether there is a possibility of the car stopping at the landing door of the nearest floor. If the possibility exists, proceed to step 704; otherwise, proceed to step 705.

In some examples, the landing door available for the car to stop at the nearest floor is limited to a landing door located above the car that is closest to the current position of the car or a landing door located below the car that is closest to the current position of the car. Further, in the rescue mode, the car moves only by gravity, and the direction of movement depends on the relative magnitude between the car load and the weight of the counterweight. From the above, when determining the possibility, in addition to considering whether it is suitable for stopping (e.g., whether or not the landing door switch of the closest landing door is in a normal state), the direction of the car's movement also needs to be considered. For example, if the car is located between the 7th and 8th floors in the case of the abnormal events mentioned above, the landing doors provided on the 7th and 8th floors are considered to be the closest landing doors. If the landing door switches provided on the 7th and 8th floors are in a normal state (such as the closed state) but the car will move upward under gravity, the landing door on the 8th floor is determined to be the landing door available for the car to stop at the nearest floor. At this time, it will be determined that there is a possibility of the car stopping at the landing door of the nearest floor. If the landing door switch provided on the 8th floor is in an abnormal state (such as the open state) and the car moves upward under gravity, it will be determined that there is no landing door available for the car to stop at the nearest floor. At this time, it will be determined that there is no possibility of the car stopping at the landing door of the nearest floor.

In step 704, the control device cuts off the power supply to the non-safety function unit of the elevator, the car is caused to move toward the landing door available for the car to stop at the nearest floor at a speed of movement lower than the safety speed by means of gravity by controlling the state of the holding brake device.

After step 704, the process shown in FIG. 7 proceeds to step 706, in which the control device determines, for example, based on the position signal provided by the rescue encoder, whether or not the car stops at the target landing door, and if so, proceed to step 707, otherwise proceed to step 708.

In step 707, the control device instructs the car controller to open the car door.

In step 708, the control device determines, based on the second status signal of the landing door switch array, whether the landing door available for the car to stop at the nearest floor has become unavailable or unsafe, and if it has become unavailable or unsafe, exits the rescue mode and proceeds to step 705, otherwise returns to step 704.

Returning to another branch step 705 of step 703, in which the control device alerts an external device (e.g., a remote server, a cloud, and a mobile terminal or client device of a maintenance person).

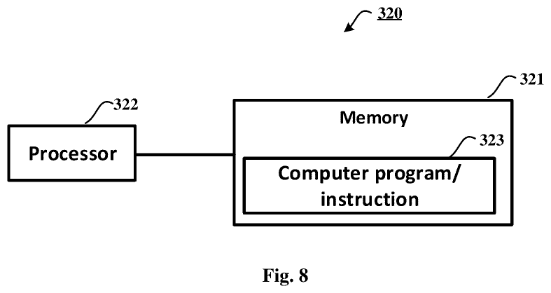

FIG. 8 is a schematic block diagram of a safety controller in FIG. 3. The safety controller 320 shown in FIG. 8 comprises one or more memories 321 (e.g., non-volatile memory such as flash memory, ROM, hard disk drives, magnetic disks, optical disks, etc.), one or more processor cores 322, and computer program/instruction 323.

The memory 321 stores the computer program/instruction 323 that may be executed by the processor core 322. In addition, the memory 321 may also store data generated by the processor core 322 in executing the computer program/instruction 323 and status signals received via the various interface units in FIG. 3.

The processor core 322 is configured to run the computer program/instruction 323 stored on the memory 321 and perform access operations to the memory 322.

The computer program/instruction 323 may include computer instruction code for implementing various functions and operations described with the aid of FIGS. 2 to 7, enabling these functions and operations to be implemented by running the computer program/instruction 323 on the processor core 322.

Those skilled in the art will appreciate that various illustrative logical blocks, modules, circuits, and algorithm steps described herein may be implemented as electronic hardware, computer software, or combinations of both.

To demonstrate this interchangeability between the hardware and software, various illustrative components, blocks, modules, circuits, and steps have been described above generally in terms of their functionality. Whether such functionality is implemented in hardware or software depends on the particular application and design constraints imposed on the overall system. Those skilled in the art may implement the described functionality in changing ways for the particular application. However, such implementation decisions should not be interpreted as causing a departure from the scope of the present disclosure.

Although only a few of the specific embodiments of the present disclosure have been described, those skilled in the art will appreciate that the present disclosure may be embodied in many other forms without departing from the spirit and scope thereof. Accordingly, the examples and implementations shown are to be regarded as illustrative and not restrictive, and various modifications and substitutions may be covered by the present disclosure without departing from the spirit and scope of the present disclosure as defined by the appended claims.

The embodiments and examples presented herein are provided to best illustrate embodiments in accordance with the present technology and its particular application, and to thereby enable those skilled in the art to implement and use the present disclosure. However, those skilled in the art will appreciate that the above description and examples are provided for convenience of illustration and example only. The presented description is not intended to cover every aspect of the present disclosure or to limit the present disclosure to the precise form disclosed.

What is claimed is:

1. An elevator safety control device comprising:
an interface unit configured to receive a first status signal of a first safety switch, a second status signal of a second safety switch, and a third status signal of a non-safety function unit of an elevator, wherein the second safety switch comprises a plurality of landing door switches whose status can be determined individually;
a safety controller configured to perform the following operations:
determining an occurrence of an abnormal event based on the first status signal, the second status signal and the third status signal;
determining, after determining the occurrence of the abnormal event, a possibility of a car stopping at a landing door of the nearest floor based on the second status signal; and
executing a rescue mode after determining an existence of the possibility,
wherein in the rescue mode, the car is caused to travel by gravity and stop at the landing door of the nearest floor by controlling a state of a holding brake device.

2. The elevator safety control device of claim 1, wherein the safety controller is configured to exit the rescue mode during travel of the car towards the nearest floor if it is determined that the landing door of the nearest floor is unavailable based on the second status signal.

3. The elevator safety control device of claim 1, wherein the interface unit comprises m signal input lines and n (n≥2) signal output lines, the landing door switches being divided into m (m≥2) switch groups, each signal input line being connected with a first end of each landing door switch within one of the m switch groups, and each signal output line being connected with a second end of one of the landing door switches within each of the m switch groups, the safety controller being further configured to apply a detection signal onto the i^{th} (1≤i≤m) signal input line and obtain a response signal on the n signal output lines as a second status signal of each landing door switch of the switch group connected with the i^{th} signal input line.

4. The elevator safety control device of claim 1, wherein the safety controller is configured to determine the occurrence of the abnormal event when the first status signal indicates that at least one of the following the first safety switches is in an open state: a limit switch, an overspeed switch, an upward overspeed switch, a pit climb switch, a mechanical device non-operating position indicator switch, a steel belt or wire rope slack trigger switch, and a speed limiter rope tension indicator switch.

5. The elevator safety control device of claim 1, wherein the safety controller is configured to determine the occurrence of the abnormal event when the first status signal indicates that at least one of the following the first safety switches is in an open state and a fourth status signal indicative of a rescue request is received: a car door switch, a pit stopping switch, a safety window switch, a car roof stopping device, a bumper switch, a main engine stopping device, and an emergency stopping operation panel switch.

6. The elevator safety control device of claim 1, wherein the safety controller is configured to determine the occurrence of the abnormal event when the second status signal indicates that at least one of the landing door switches is in an open state.

7. The elevator safety control device of claim 1, wherein the non-safety function unit of the elevator comprises a drive device and an elevator controller, the safety controller being configured to determine the occurrence of the abnormal event when the third status signal indicates a malfunction of the non-safety function unit of the elevator.

8. The elevator safety control device of claim 1, wherein the safety controller is configured to determine the possibility in the following manner:
determining a direction of travel of the car under gravity based on a load of the car and weight of a counterweight;
determining the existence of the possibility of the car stopping at the landing door of the nearest floor when it is determined that the landing door closest to the car in the direction of travel is in a closed state based on the second status signal.

9. The elevator safety control device of claim 1, wherein the safety controller is configured to execute the rescue mode in the following manner:
cutting off power supply to the non-safety function unit of the elevator;
in a process of causing the car to travel by gravity towards the landing door of the nearest floor, controlling a travel speed of the car below a safety speed by controlling the state of the holding brake device, using a rescue encoder as a feedback signal; and
instructing a car controller to cause a car door to open when the car stops at the landing door of the nearest floor.

10. An elevator system comprising:
a car;
a non-safety function unit of an elevator;
a first safety switch;
a second safety switch comprising a plurality of landing door switches whose status can be determined individually;
a holding brake device; and
an elevator safety control device comprising:
an interface unit configured to receive a first status signal of the first safety switch, a second status signal of the second safety switch, and a third status signal of the non-safety function unit of the elevator;
a safety controller configured to perform the following operations:
determining an occurrence of an abnormal event based on the first status signal, the second status signal and the third status signal;
determining, after determining the occurrence of the abnormal event, a possibility of the car stopping at a landing door of the nearest floor based on the second status signal; and
executing a rescue mode after determining an existence of the possibility, wherein in the rescue mode, the car is caused to travel by gravity and stop at the landing door of the nearest floor by controlling a state of the holding brake device.

11. The elevator system of claim 10, wherein the safety controller is configured to exit the rescue mode during travel of the car towards the nearest floor if it is determined that the landing door of the nearest floor is unavailable based on the second status signal.

12. The elevator system of claim 10, wherein the interface unit comprises m signal input lines and n (n≥2) signal output lines, the landing door switches being divided into m (m≥2) switch groups, each signal input line being connected with a first end of each landing door switch within one of the m switch groups, and each signal output line being connected with a second end of one of the landing door switches within each of the m switch groups, the safety controller being further configured to apply a detection signal onto the i^{th} (1≤i≤m) signal input line and obtain a response signal on the n signal output lines as a second status signal of each landing door switch of the switch group connected with the i^{th} signal input line.

13. The elevator system of claim 10, wherein the safety controller is configured to determine the occurrence of the abnormal event when the first status signal indicates that at least one of the following the first safety switches is in an open state: a limit switch, an overspeed switch, an upward overspeed switch, a pit climb switch, a mechanical device non-operating position indicator switch, a steel belt or wire rope slack trigger switch, and a speed limiter rope tension indicator switch.

14. The elevator system of claim 10, wherein the safety controller is configured to determine the occurrence of the abnormal event when the first status signal indicates that at least one of the following the first safety switches is in an open state and a fourth status signal indicative of a rescue request is received: a car door switch, a pit stopping switch, a safety window switch, a car roof stopping device, a bumper switch, a main engine stopping device, and an emergency stopping operation panel switch.

15. The elevator system of claim 10, wherein the safety controller is configured to determine the occurrence of the abnormal event when the second status signal indicates that at least one of the landing door switches is in an open state.

16. The elevator system of claim 10, wherein the non-safety function unit of the elevator comprises a drive device and an elevator controller, the safety controller being configured to determine the occurrence of the abnormal event when the third status signal indicates a malfunction of the non-safety function unit of the elevator.

17. The elevator system of claim 10, wherein the safety controller is configured to determine the possibility in the following manner:
determining a direction of travel of the car under gravity based on a load of the car and weight of a counterweight;
determining the existence of the possibility of the car stopping at the landing door of the nearest floor when it is determined that the landing door closest to the car in the direction of travel is in a closed state based on the second status signal.

18. A method for elevator safety control comprising:
receiving a first status signal of a first safety switch, a second status signal of a second safety switch, and a third status signal of a non-safety function unit of an elevator, wherein the second safety switch comprises a plurality of landing door switches whose status can be determined individually;
determining an occurrence of an abnormal event based on the first status signal, the second status signal and the third status signal;
determining, after determining the occurrence of the abnormal event, a possibility of a car stopping at a landing door of the nearest floor based on the second status signal; and
executing a rescue mode after determining an existence of the possibility, wherein in the rescue mode, the car is caused to travel by gravity and stop at the landing door of the nearest floor by controlling a state of a holding brake device.

19. A non-transitory computer-readable storage medium having stored thereon a computer program/instruction that implements the steps of the method as claimed in claim 18 when the computer program/instruction is executed by a processor.
